(19) United States
(12) Patent Application Publication
(10) Pub. No.: US 2013/0226391 A1
(43) Pub. Date: Aug. 29, 2013

(54) DIAGNOSTIC METHOD AND DIAGNOSTIC DEVICE FOR A VEHICLE COMPONENT OF A VEHICLE

(71) Applicants: Stefan NORDBRUCH, Kornwestheim (DE); Michael KNOOP, Ludwigsburg (DE)

(72) Inventors: Stefan NORDBRUCH, Kornwestheim (DE); Michael KNOOP, Ludwigsburg (DE)

(73) Assignee: Robert Bosch GmbH, Stuttgart (DE)

(21) Appl. No.: 13/779,073

(22) Filed: Feb. 27, 2013

(30) Foreign Application Priority Data
Feb. 27, 2012 (DE) 102012202914.1

(51) Int. Cl. G06F 17/00

(52) U.S. Cl. CPC G06F 17/00
USPC 701/29.3; 701/31.4

(57) ABSTRACT

A diagnostic method for a vehicle component of a vehicle, a plurality of vehicles each having the same vehicle component being provided; during the operation of the vehicles, an operating parameter of the respective vehicle component being recorded and, as a function of the recorded operating parameter, a status message corresponding to the status of the respective vehicle component being sent to a server for an evaluation of the status message. A corresponding diagnostic device, a corresponding diagnostic system and a computer program are also described.

### CROSS REFERENCE

The present application claims the benefit under 35 U.S.C. §119 of German Patent Application No. DE 102012202914.1 filed on Feb. 27, 2012, which is expressly incorporated herein by reference in its entirety.

### FIELD

The present invention relates to a diagnostic method and a diagnostic device for a vehicle component of a vehicle. Furthermore, the present invention relates to a diagnostic system for a vehicle component of a vehicle and a computer program.

### BACKGROUND INFORMATION

An impending failure of vehicle systems of a motor vehicle is generally not systematically detected. Some systems are tested at greater intervals at repair station inspections, and other systems are not tested at all. This is why an impending failure of an important system is frequently not able to be detected early enough. These systems may therefore fail, for instance, during the operation of the vehicle.

### SUMMARY

An object of the present invention is to provide a diagnostic method for a vehicle component of a vehicle, which overcomes the conventional disadvantages, and in which the probability of failure of the vehicle component during vehicle operation is reduced or avoided.

An object of the present invention is also to provide a corresponding diagnostic device, a corresponding diagnostic system and a corresponding computer program.

According to one aspect, an example diagnostic method is provided for a vehicle component of a vehicle. In this instance, a plurality of vehicles are provided each with the same vehicle component. During the operation of the vehicles, an operating parameter of the respective vehicle component is recorded, and, as a function of the recorded operating parameter, a status message corresponding to a status of the respective vehicle component being sent to a server outside the vehicle for an evaluation of the status message.

According to one further aspect, an example diagnostic device for a vehicle component of a vehicle is provided. The diagnostic device includes a recording device for recording an operating parameter of the vehicle component. The diagnostic device further includes a sending device for sending a status message corresponding to the recorded operating parameter to a server external to the vehicle for an evaluation of the status message.

According to still another aspect, an example diagnostic system is provided for a vehicle component of a vehicle. The diagnostic system includes the abovementioned diagnostic device as well as a server external to the vehicle, for an evaluation of the status message.

According to a further aspect, an example computer program is provided, which includes program code to execute the diagnostic method for a vehicle component of a vehicle, when the computer program is run on a computer.

That is, the present invention includes particularly the idea of transmitting status data, in this case especially the status message, from the vehicle component, which may be included in a vehicle system, for example, in which a functional restriction that is foreseeable or has already taken place, via suitable communications, preferably wireless, to the server external to the vehicle, wherein the server external to the vehicle may belong to a vehicle manufacturer, a supplier of a vehicle system or the vehicle component, and/or to a repair station. The receiver of the status message, that is, particularly the vehicle manufacturer, the supplier of the system or the repair station, analyzes the functional disturbance, which thus means that the receiver, in particular, carries out an evaluation of the status message. Because a plurality of vehicles is provided each with the same vehicle component, a considerable data set having a multiplicity of status messages is formed, so that a statistically simple evaluation is made possible. Furthermore, it may thus be detected early, in an advantageous manner, whether perhaps the vehicle component has a serial defect. Consequently, it is particularly additionally made possible, in an advantageous manner, currently and in time to take suitable measures, for instance, a recall action, for the vehicle component.

The plurality of vehicles is preferably a representative sample of vehicles.

The recording of the operating parameters particularly has the effect that the status of the vehicle component is able to be recorded, or rather determined. Thus one may make a statement particularly in an advantageous manner on whether a functional restriction of the vehicle component exists or is foreseeable. Correspondingly, the status message may then particularly be formed that is sent to the server external to the vehicle, to evaluate this.

According to one specific embodiment, a vehicle component may be selected, such as a vehicle component selected from the group of vehicle components: drive system, brake system, steering system, illumination system, signaling devices of the vehicle, driver assistance system, for instance, an electronic stability program (ESP) system, an adaptive cruise control system (ACC), a damping system, a video system, a radar system, a navigation system, a chassis and suspension system, a communications system, an engine system, a transmission system and an air conditioning system.

According to another specific embodiment, a plurality of vehicle components may also be provided in the vehicles. The vehicle components may preferably be formed to be equal or different. That is, this means in particular that according to this specific embodiment, a respective operating parameter of the vehicle components of the plurality of vehicles is recorded, and then, analogously to the specific embodiment, status messages corresponding to a vehicle component are formed and sent to the server external to the vehicle as a function of the recorded operating parameter.

According to one specific embodiment, the recording of the operating parameter includes particularly the monitoring of sensors, such as temperature sensors, voltage sensors, current sensors or pressure sensors, which are able to measure appropriate physical variables of the vehicle component. It may particularly be provided that one should monitor the sensors using signal-based monitoring and/or model-supported monitoring. Signal-based monitoring may include, for instance, monitoring a measuring range, a gradient, a signal peak or an erroneously constant signal. Model-supported monitoring may include, for example, the monitoring of an analytical redundancy.

According to one specific embodiment, the recorded operating parameter may be recorded to a setpoint operating parameter value. A deviation lasting for a longer period of time, which increases with time, that is, becomes larger, in an advantageous manner, permit one to conclude that there has been a creeping systems error. This means particularly that it may be provided that a curve over time of the operating parameter is recorded and a deviation of the operating parameter from a setpoint operating parameter value is recorded, the status message being sent to the server that is external to the vehicle as a function of the deviation.

By the formulation “external to the vehicle” is meant a location, or rather a position outside the vehicle. This, then, means particularly that the server outside the vehicle is situated outside the vehicle, that is, externally to it. This, then, means particularly that the server outside the vehicle is not located in or on the vehicle.

According to a specific embodiment, a communication between the vehicles and the server external to the vehicle preferably is implemented using a wireless communication method. This, then, means particularly that the status message is sent to the server that is external to the vehicle using the wireless communications method. A wireless communications method may be, for instance, a WLAN communications method, a mobile radio communications method, for example, a “long term evolution” (LTE) mobile radio communications method. It may preferably be provided that the status message be sent using an e-mail and/or using an SMS to the server external to the vehicle. The communication between the vehicles and the server external to the vehicle may be encrypted, for example. A respective communication between the vehicles may particularly be performed in the same way or differently.

According to one specific embodiment, the operating parameter may include an intervention intensity of an actuator of the vehicle component. It may preferably be provided that the intervention intensity be integrated over the operating duration of the vehicle component. This may analogously also apply in general to the operating parameter. This, then means particularly that the recorded operating parameter is integrated over the operating duration of the vehicle component. An intervention intensity of an actuator may, for instance, be a pressure, particularly a pressure increase, of an electronic stability program (ESP) hydraulic unit. A comparison to design limits may preferably be provided, especially having design limits of the aforementioned ESP hydraulic unit.

According to one specific embodiment, an operating parameter may also include the rotational speed of a motor, for instance, a drive motor or a pump motor. An operating parameter may preferably include information on a current actuator actuation, for instance, supplying with current one or more valves of an ESP.

An operating parameter within the meaning of the present invention designates particularly a parameter which describes a physical variable of the vehicle component, or corresponds to a physical condition of the vehicle component.

According to one specific embodiment, it may be provided that the status message is sent already during the operation of the corresponding vehicle. It may preferably be provided that the status message be sent directly in time after the forming of the status message to the server external to the vehicle. This, then means particularly that, still during the operation of the vehicle, the manufacturer, the supplier and/or the repair station are able to acquire knowledge on an impending functional restriction or the functional restriction, and may preferably resort to appropriate measures.

In another specific embodiment, it may be provided that the operating parameter and the status message be transmitted to a respective central communications device of the vehicle, the central communications device being able to send the operating parameter and/or the status message to the server external to the vehicle. This, then means particularly that in each case a central communications device is able to be provided in the vehicles, which carries out the sending of the status message or the operating parameter to the server external to the vehicle. Because of this, not every vehicle component itself has to have a corresponding communications system. A single communications system is advantageously sufficient in this instance, in this case, the central communications system, which takes over all communications between the vehicle and the server external to the vehicle. Such a central communications device is preferably present in only a part of the plurality of the vehicles.

According to a further specific embodiment, it may be provided that a respective operating parameter be recorded by additional different vehicle components, whereby, as a function of the recorded operating parameters, in each case a status message corresponding to the respective status of the additional vehicle components is transmitted to a central diagnostic device that is internal to the vehicle, which, as a function of the transmitted status messages, sends the status message to the server external to the vehicle. This, then means in particular that the individual vehicle components transmit their respective status, that is, their status in the context of a plurality of vehicle components, also designated as substatus, to the central diagnostic device, which thereupon, in an advantageous manner, is then able to form a status corresponding to the overall status corresponding to the plurality of vehicle components, so that it is then able to be sent to the server external to the vehicle. Because of that, the receiver of the status message is able to receive an overview of the overall status of the vehicle with its individual systems including the plurality of vehicle components. An even more inclusive and more accurate error analysis is thus made possible in an advantageous manner. Such a diagnostic device may preferably be provided respectively in all vehicles.

According to another specific embodiment, it may be provided that the recording device be integrated into a control of the vehicle component.

In another specific embodiment it may be provided that a central diagnostic device is provided which is connected to the recording device using a bus. Such a bus may be a field bus, for example. In particular, such a bus is a CAN bus. In this instance, the formulation “CAN” stands for “controller area network”. This, then means in particular that using the bus advantageously makes possible the networking of the control units of the vehicle components.

Within the meaning of the present invention, the formulation “internal to the vehicle” designates a location, or rather a position on or within the vehicle. This, then means especially that a diagnostic device internal to the vehicle, or rather a communications device internal to the vehicle is located in each case in, or on at least one part of the plurality of vehicles. All vehicles preferably each have such a diagnostic device internal to the vehicle and/or such a communications device internal to the vehicle.

The formulation “central” within the meaning of the present invention designates particularly that the corresponding device, apparatus or system is used as a superordinate instance for the corresponding functionalities. This therefore means, for example, that a central control unit, or a central controller is connected to, or networked with additional controllers and advantageously controls them and/or advantageously receives data from them. That is, a central communications device, in particular, advantageously takes over as superordinate instance the communication between the vehicle and the server that is external to the vehicle, or additional servers that are external to the vehicle. A central diagnostic device also advantageously takes over as superordinate instance the diagnosis of the overall system including the plurality of vehicle components.

According to a further specific embodiment, it may be provided that the central diagnostic device is integrated into a central communications device including the sending device.

According to a further specific embodiment, it may be provided that, in at least one vehicle, particularly in all vehicles, in addition, the corresponding operating parameter is sent to the server external to the vehicle.

According to a further specific embodiment, it may be provided that, in at least one vehicle, preferably in all vehicles, an environmental parameter corresponding to the vehicle environment is recorded and correlated in time to the recorded operating parameter. This, then means particularly that, based on the correlation, a statement can be made as to at which time, with respect to the time of recording the operating parameter, the environmental parameter was recorded.

According to a further specific embodiment, it may be provided that, in at least one vehicle, preferably in all vehicles, a travel route parameter is recorded and is correlated in time to the recorded operating parameter. This, then means particularly that, based on the correlation, a statement can be made as to at which time with respect to the time of recording the operating parameter, the travel route parameter was recorded.

According to a further specific embodiment, it may be provided that, in at least one vehicle, preferably in all vehicles, a vehicle status parameter is recorded and is correlated in time to the recorded operating parameter. This, then means particularly that, based on the correlation, a statement can be made as to at which time, with respect to the time of recording the operating parameter, the travel route parameter was recorded.

Travel route parameters, within the meaning of the present invention, may be a travel route, a roadway and/or radii of curve.

Vehicle status parameters within the meaning of the present invention particularly designate vehicle-dynamic parameters such as an instantaneous vehicle speed and/or an instantaneous vehicle acceleration. Vehicle status parameters within the meaning of the present invention include, in particular, parameters which specify a vehicle status.

Environmental parameters within the meaning of the present invention particularly designate parameters which specify a vehicle environment, i.e. the surroundings of the vehicle. This, then, means particularly that a vehicle environment is recorded in a measurement technology manner. Thus, it may be provided, for example, that a temperature, wetness, rain, snow and/or elevation information are recorded.

According to still another specific embodiment, it may be provided that a data packet including a recorded operating parameter and the status message is formed. This data packet may then be advantageously sent to the server external to the vehicle, so that it is able to evaluate the data packet appropriately. Thereby, in an advantageous manner, both the status message and the recorded operating parameter may efficiently be sent to the server external to the vehicle in one sending process.

The present invention is explained below in greater detail with reference to preferred exemplary embodiments.

### BRIEF DESCRIPTION OF THE DRAWINGS

FIG. 1 shows a flow chart of a diagnostic method.

FIG. 2 shows a diagnostic device.

FIG. 3 shows a diagnostic system.

FIG. 4 shows an additional diagnostic system.

FIG. 5 shows one additional diagnostic device.

### DETAILED DESCRIPTION OF EXAMPLE EMBODIMENTS

In the following text, the same reference numerals are used for the same features.

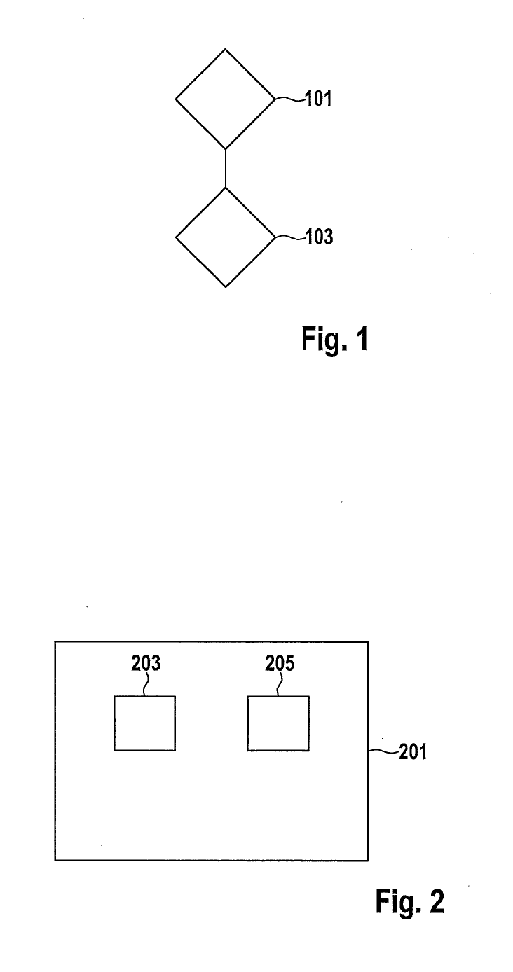

FIG. 1 shows a flow chart of a diagnostic method for a vehicle component of a vehicle. In this instance, a plurality of vehicles are provided each with the same vehicle component. According to a step 101, an operating parameter of the respective vehicle component is recorded during the operation of the vehicle. During a step 103, as a function of the recorded operating parameter, a status message corresponding to a status of the respective vehicle component is sent to a server outside the vehicle for an evaluation of the status message.

FIG. 2 shows a diagnostic device 201 for a vehicle component (not shown) of a vehicle (not shown).

Diagnostic device 201 includes a recording device 203 for recording an operating parameter of the vehicle component. In addition, diagnostic device 201 includes a sending device 205 for sending a status message corresponding to a status of the vehicle component to a server external to the vehicle (not shown here) for an evaluation of the status message, the sending of the status message being carried out as a function of the recorded operating parameter.

According to a specific embodiment that is not shown, it may be provided that the recording device be integrated into a controller of the vehicle component. In a further specific embodiment not shown, the central communications device may be provided, into which the sending device is integrated. The central communications device is preferably developed to be situated in a vehicle or on a vehicle. In such a case, the central communications device may then be designated as a central communications device internal to the vehicle.

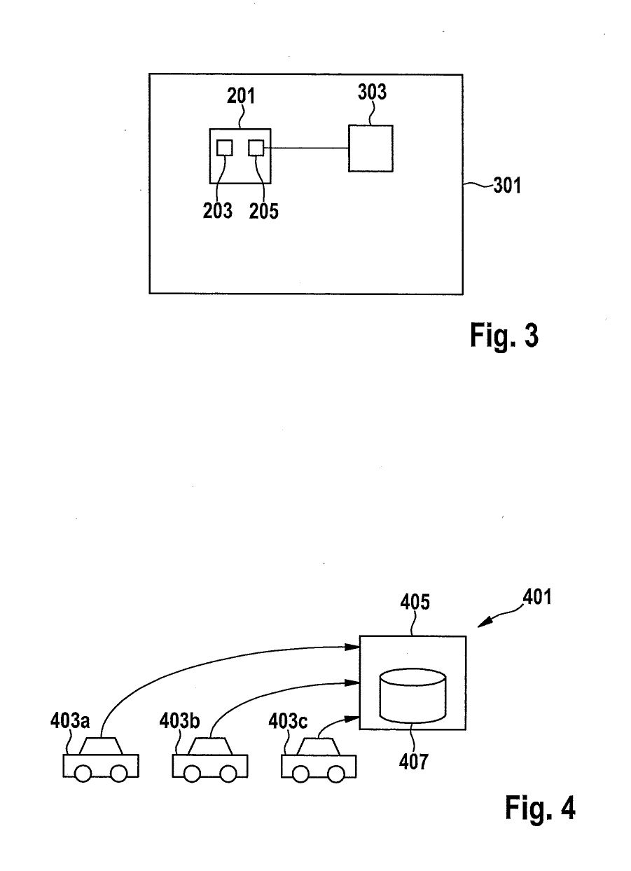

FIG. 3 shows a diagnostic system 301 for a vehicle component of a vehicle.

Vehicle system 301 includes diagnostic device 201 according to FIG. 2, as well as a server 303 external to the vehicle for the evaluation of the status message.

FIG. 4 shows an additional diagnostic system 401 for a vehicle component, in each case the same vehicle component being situated in a plurality of vehicles 403a, 403b and 403c.

In vehicles 403a, b, c, a diagnostic device in FIG. 4 is situated in each case. This device monitors in each case particularly one or more vehicle components of vehicles 403a, b, c for a possible functional restriction or a functional failure. To the extent that such a functional restriction is foreseeable or has already occurred, a corresponding status message is sent by the corresponding vehicle to a server 405 that is external to the vehicle.

Server 405 that is external to the vehicle includes a repair data bank 407, for example. Repair data bank 407 includes particularly repair-relevant data. This, then means particularly that the data, which are stored in repair data bank 407, are relevant for a repair of the vehicle component of vehicle 403. The status message is evaluated by server 405 that is external to the vehicle, especially based on the repair data of repair data bank 407.

In an exemplary embodiment, more or fewer than three vehicles 403a, b, c may be provided. By the provision of a plurality of vehicles, a data set is available that is sufficiently large for a statistical evaluation, so that serial defects in the vehicle component, for example, may advantageously be detected rapidly and simply.

In a specific embodiment, it may be provided that at least one of the following parameters be sent to server 405 that is external to the vehicle:
operating mode of the system at the conclusion of the impending failure, for instance, in response to the pressure drop in the ESP hydraulic unit by modulation, active pressure buildup,
current actuator actuation, for instance, by the ESP: supplying the valves with current, rotational speed of pump motor,
parameters relate to the question as to which system checking or which vehicle component has reported an error,
a parameter relating to a signal-based monitoring (value range, gradient, peaks of a signal),
a parameter relating to a model-based monitoring (checking the plausibility of a plurality of signals with respect to one another by evaluating model relationships),
additional vehicle-specific parameters, such as operating voltage,
current speed and accelerations,
environmental conditions, to the extent of being recorded by measuring technology, such as temperature, wetness, rain, snow, height data,
travel route data to the extent recorded, such as travel route, roadway, preferably curve radii,
the age of the system and of the vehicle component (manufacturing date, production number, etc.),
maintenance data of the system and of the vehicle component (repair shop visits, etc.).

In another specific embodiment, the diagnostic methods may include the following steps:
conclusion on the impending failure in the control unit and in the control of the affected system and the affected vehicle component,
collection of failure parameters, that is, in particular, of the operating parameters, composition to a data packet especially including the operating parameters and a corresponding status message,
transmission of the data packet, via data bus internal to the vehicle, to a communications unit and communications control,
sending out the data packet by wireless communication, for instance, via mobile radio.

The following parameters and results may particularly be formed from an evaluation of the status messages, the parameters being particularly relevant to quality and particularly making possible a statement concerning the quality of manufacturing. That being the case, such corresponding parameters may also be designated as quality-relevant manufacturing parameters:
mechanical tolerances,
electrical tolerances,
robustness of components to environmental conditions (temperature, overvoltage).

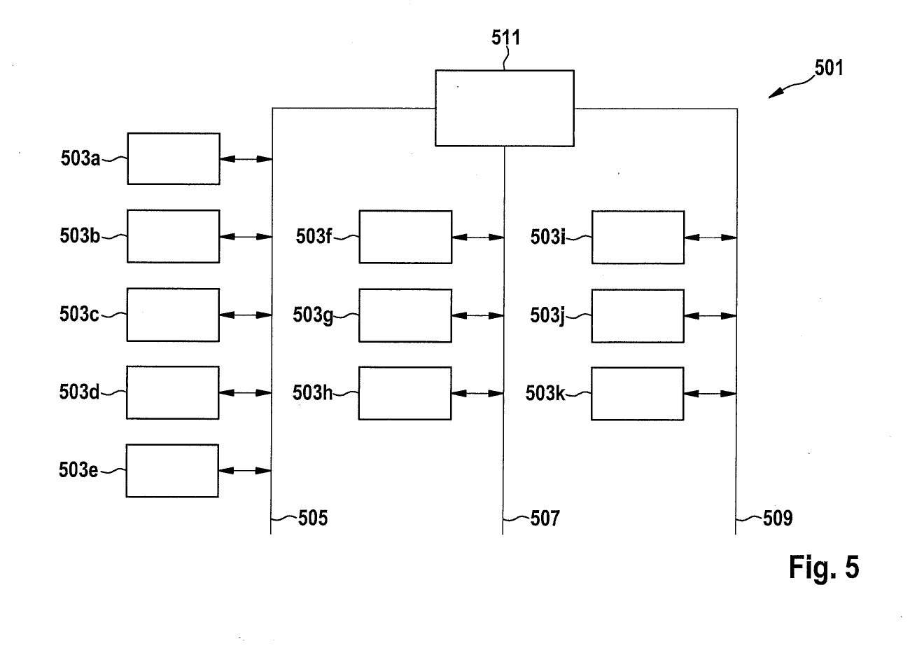

FIG. 5 shows an additional diagnostic device 501 for a vehicle component (not shown) of a vehicle (not shown).

Diagnostic device 501 includes a plurality of recording devices, not shown here in detail, in each case one of the recording devices being integrated into a controller for a vehicle component of the vehicle. The controllers for the corresponding vehicle components are characterized in FIG. 5 using reference symbols 503a to 503k.

In this instance, reference symbol 503a characterizes an ESP controller. Reference symbol 503b characterizes an ACC controller. Reference symbol 503c characterizes a video controller. Reference symbol 503d characterizes a controller for a damper adjustment. Reference symbol 503f characterizes a motor controller. Reference symbol 503g characterizes a transmission controller. Reference symbol 503i characterizes a communications controller. Reference symbol 503j characterizes a navigation controller. In one specific embodiment that is not shown, more or fewer controllers may also be provided.

The individual controllers 503a to 503k are connected via buses. In this instance, controllers 503a to 503e are connected using a chassis bus 505. Controllers 503f to 503h are connected to one another via a drive bus 507. Controllers 503i to 503k are connected using a multimedia bus 509.

Buses 505, 507 and 509 are connected to a central diagnostic device 511. Central diagnostic device 511 accepts the interference messages, that is, the substatus messages, of controllers 503a to 503k. From these substatus messages, central diagnostic device 511 derives a technical overall judgment and forms a corresponding status message in this respect. Diagnostic device 511 is then able to request the sending or depositing the status message, for instance, in a central communications device not shown here.

The design described according to FIG. 5 may also be designated as a central architecture, to the extent that, in this case, central diagnosis device 511, as the central superordinate instance, accepts the interference messages of controllers 503a to 503k. By contrast to this, in a specific embodiment not shown here, a decentralized architecture may be provided. This, then means particularly that each controller 503a to 503k, via a suitable communication, such as a data bus, requests the depositing of the corresponding substatus message at a communications controller, such as communications controller 503i, if it detects within its purview, that is the range relating to the vehicle component, which is being range relating to the vehicle component, which is being controlled using the corresponding controller, an impending technical problem, that is, for example, a functional restriction or a functional failure.

The central architecture variant particularly advantageously makes possible that data from a plurality of controllers are able to be evaluated to make a judgment of the functionability of a vehicle component. This particularly enables a still more accurate and more inclusive diagnosis of the vehicle component.

According to one specific embodiment that is not shown, it may be provided that central diagnostic device 511 be integrated into a gateway control. Such a gateway control is usually connected in a communications network, for instance, a bus system, to a plurality of data buses, in this case, buses 505, 507 and 509, and thus advantageously has access to many data, especially of individual controllers 503a to 503k.

The specific embodiments of a diagnostic device just described may be installed, for instance, in all vehicles or in only a part of the vehicles, the diagnostic devices installed being able to be formed the same or differently.

What is claimed is:

1. A diagnostic method for a vehicle component of a vehicle, a plurality of vehicles being provided with the same vehicle component in each case, the method comprising:
recording an operating parameter of the respective vehicle component during an operation of the vehicles; and
sending a status message corresponding to a status of the respective vehicle component as a function of the recorded apparatus parameters, the status message being sent to a server outside the vehicle for an evaluation of the status message.

2. The diagnostic method as recited in claim 1, wherein, in at least one vehicle, the corresponding operating parameter is additionally sent to the server that is external to the vehicle.

3. The diagnostic method as recited in claim 2, wherein, in at least one vehicle, the operating parameter and the status message is transmitted to a central communications device of the vehicle for the sending of the operating parameter and of the status message to the server that is external to the vehicle.

4. The diagnostic method as recited in claim 1, wherein, in at least one vehicle, a respective operating parameter of additional different vehicle components is recorded and, as a function of the recorded operating parameters, in each case a status message corresponding to the respective status of the additional vehicle components is transmitted to a central diagnostic device that is internal to the vehicle, which, as a function of the transmitted status messages, sends the status message to the server that is external to the vehicle.

5. The diagnostic method as recited in claim 1, wherein, in at least one vehicle, an environmental parameter corresponding to a vehicle environment is recorded and is correlated in time to the recorded operating parameter.

6. The diagnostic method as recited in claim 1, wherein, in at least one vehicle, a travel route parameter is recorded and is correlated in time to the recorded operating parameter.

7. The diagnostic method as recited in claim 1, wherein, in at least one vehicle, a vehicle status parameter is recorded and is correlated in time to the recorded operating parameter.

8. A diagnostic device for a vehicle component of a vehicle, comprising:
a recording device to record an operating parameter of the vehicle component; and
a sending device to send a status message corresponding to the recorded operating parameter to a server that is external to the vehicle, for an evaluation of the status message.

9. The diagnostic device as recited in claim 8, wherein the recording device is integrated into a controller of the vehicle component.

10. The diagnostic device as recited in claim 8, wherein a central diagnostic device is provided, which is connected to the recording device using a bus.

11. The diagnostic device as recited in claim 10, wherein the central diagnostic device is integrated into a central communications device including the sending device.

12. A diagnostic system for a vehicle component of a vehicle, comprising:
a diagnostic device including a recording device to record an operating parameter of the vehicle component, and a sending device to send a status message corresponding to the recorded operating parameter to a server that is external to the vehicle, for an evaluation of the status message; and
a server external to the vehicle to evaluate the status message.

13. A computer readable storage medium storing a computer program including program code for a diagnostic method for a vehicle component of a vehicle, a plurality of vehicles being provided with the same vehicle component in each case, the program code, when executed by a computer, causing the computer to perform the steps of:
recording an operating parameter of the respective vehicle component during an operation of the vehicles; and
sending a status message corresponding to a status of the respective vehicle component as a function of the recorded apparatus parameters, the status message being sent to a server outside the vehicle for an evaluation of the status message.
